(19) United States
(12) Patent Application Publication
(10) Pub. No.: US 2021/0140443 A1
(43) Pub. Date: May 13, 2021

(54) FRP IMPELLER FOR VEHICLE SUPERCHARGER

(71) Applicant: IHI Corporation, Koto-ku (JP)

(72) Inventors: Akihiro YAMAGATA, Koto-ku (JP); Takaomi INADA, Koto-ku (JP); Atsushi YASUMURO, Koto-ku (JP)

(73) Assignee: IHI Corporation, Koto-ku (JP)

(21) Appl. No.: 16/622,665

(22) PCT Filed: Jun. 15, 2018
(86) PCT No.: PCT/JP2018/022946

§ 371 Date: Dec. 13, 2019

(30) Foreign Application Priority Data
Jun. 16, 2017 (JP) 2017-118853

(51) Int. Cl. F04D 29/28; F04D 29/02; F02C 6/12

(52) U.S. Cl. CPC F04D 29/284; F04D 29/023; F05D 2300/603; F05D 2220/40; F02C 6/12

(57) ABSTRACT

An FRP impeller for a vehicle turbocharger includes a boss portion, a disk portion, and a plurality of blade portions. The disk portion includes a front surface on which the blade portions are formed, and a rear surface located opposite the front surface in the axis direction. The disk portion has, on the rear surface, an end edge being annular and located on another side of the axis direction, and a recessed portion formed inward of the end edge in the radius direction and recessed more toward the one side of the axis direction than the end edge. The recessed portion includes a planar surface being annular, located at a bottom portion of the recessed portion farthest from the end edge in the axis direction, and extending along the radius direction.

### TECHNICAL FIELD

The present disclosure relates to an FRP impeller for a vehicle turbocharger.

### BACKGROUND ART

As disclosed in Patent Documents 1 and 2, impellers for centrifugal compressors are known. The impeller disclosed in Patent Document 1 includes a hub portion formed on a rotational axis, and a plurality of blade portions attached to an outer peripheral surface of the hub portion. The blade portions are formed from a discontinuous fiber resin and at least a rear part of the hub portion is formed from a continuous fiber resin. The impeller of Patent Document 2 has a recessed portion formed on a rear surface thereof.

### CITATION LIST

### Patent Literature

Patent Document 1: Japanese Unexamined Patent Publication No. 2014-238084

Patent Document 2: Japanese Unexamined Patent Publication No. 2011-085088

### SUMMARY OF INVENTION

### Technical Problem

A hub portion (disk portion) of a fiber reinforced plastic (FRP) impeller conventionally employs a shape that protrudes toward the rear surface to relieve stress on an inner diameter portion of a boss portion. The weight and the moment of inertia of the impeller may be increased in such case. As a result, acceleration performance tends to decrease. An impeller having a recessed portion formed on a rear surface is also known as disclosed in Patent Document 2. By having the recessed portion formed, weight can be reduced.

The recessed portion on the rear surface of the impeller can contribute to improving acceleration performance and reducing weight. In other words, inertia can be reduced. The reduction in inertia is important in a compressor for a vehicle turbocharger which requires acceleration performance of the impeller. However, merely having a recessed portion increases stress. An increase in stress may cause damage to the impeller. The present disclosure describes an FRP impeller for a vehicle turbocharger that can prevent damage.

### Solution to Problem

An FRP impeller for a vehicle turbocharger according to one embodiment of the present disclosure includes a boss portion being cylindrical and having an axis, a disk portion extending outward in a radius direction from the boss portion, and a plurality of blade portions protruding outward in the radius direction and toward one side of an axis direction along the axis from the boss portion and the disk portion, wherein the disk portion includes a front surface on which the blade portions are foisted, and a rear surface located opposite the front surface in the axis direction, wherein the disk portion has, on the rear surface, an end edge being annular and located on another side of the axis direction, and a recessed portion formed inward of the end edge in the radius direction and recessed more toward the one side of the axis direction than the end edge, and wherein the recessed portion includes a planar surface being annular, located at a bottom portion of the recessed portion farthest from the end edge in the axis direction, and extending along the radius direction.

### Advantageous Effects of Invention

One embodiment of the present disclosure provides an FRP impeller for a vehicle turbocharger that can prevent damage.

### BRIEF DESCRIPTION OF DRAWINGS

FIG. 1 is a cross-sectional view showing an electric turbocharger having an FRP impeller for a vehicle turbocharger according to an embodiment of the present disclosure applied thereto.

FIG. 2 is a cross-sectional view showing the FRP impeller for a vehicle turbocharger of FIG. 1.

FIG. 3 is an enlarged cross-sectional view of a portion of the FRP impeller for a vehicle turbocharger of FIG. 2.

FIG. 4 is a diagram showing the shapes of a recessed portion and an end surface of the FRP impeller for a vehicle turbocharger of FIG. 2.

FIG. 5 is a diagram showing the relationship between stress of parts of an impeller and inertia thereof in cases in which the shape of the recessed portion varies.

FIG. 6 is a diagram showing stress distribution on a rear surface of an FRP impeller for a vehicle turbocharger according to an example.

FIG. 7 is a diagram showing stress distribution on a rear surface of an FRP impeller for a vehicle turbocharger according to a comparative example.

FIG. 8 is a cross-sectional view showing an FRP impeller for a vehicle turbocharger according to another embodiment of the present disclosure.

### DESCRIPTION OF EMBODIMENTS

An FRP impeller for a vehicle turbocharger according to one embodiment of the present disclosure includes a boss portion being cylindrical and having an axis, a disk portion extending outward in a radius direction from the boss portion, and a plurality of blade portions protruding outward in the radius direction and toward one side of an axis direction along the axis from the boss portion and the disk portion, wherein the disk portion includes a front surface on which the blade portions are formed, and a rear surface located opposite the front surface in the axis direction, wherein the disk portion has, on the rear surface, an end edge being annular and located on another side of the axis direction, and a recessed portion formed inward of the end edge in the radius direction and recessed more toward the one side of the axis direction than the end edge, and wherein the recessed portion includes a planar surface being annular, located at a bottom portion of the recessed portion farthest from the end edge in the axis direction, and extending along the radius direction.

In this FRP impeller for a vehicle turbocharger, the recessed portion formed in the rear surface of the disk portion can contribute to reducing inertia and improving acceleration performance. Since the recessed portion has, on the bottom portion, the planar surface that extends along the radius direction, an increase in stress is prevented compared to a case in which the recessed portion is greatly hollowed out. Thus, this FRP impeller for a vehicle turbocharger is capable of preventing damage.

In some embodiments, a ratio of a maximum depth being a depth from the end edge to the planar surface in the axis direction, to a radius of the disk portion is 10 to 25%. In this case, the increase in stress is more appropriately prevented.

In some embodiments, the recessed portion includes a sloped surface connecting the planar surface to the end edge, and the sloped surface includes an inflection point in a cross-sectional shape taken in a plane including the axis. Since the inflection point is located between the planar surface and the end edge in this case, the shape of the recessed portion from the planar surface to the outer circumferential side can be appropriately set.

In some embodiments, the inflection point is located at a position between 40 to 60% of the disk portion in the radius direction from the axis. In this case, the shape of the recessed portion from the planar surface to the outer circumferential side is optimized.

In some embodiments, a ratio of a length in the radius direction of a region including the planar surface and having a depth in the axis direction 10% or less of the maximum depth, to the radius of the disk portion is 10 to 25%. In this case, the size of the region of the planar surface to be formed in the recessed portion cart be appropriately set. As a result, inertia is reduced and the increase in stress is prevented.

In some embodiments, a ratio of a length of the planar surface in the radius direction to the radius of the disk portion is 5 to 8%. In this case, the size of the region of the planar surface to be formed is optimized.

In some embodiments, a ratio of a length in the radius direction of a region including the planar surface and having a slope angle with respect to the planar surface of 20° or less, to the radius of the disk portion is 13 to 25%. In this case, the size of the region that includes the planar surface and both sides of the planar surface in the radius direction can be appropriately set. As a result, inertia is reduced and the increase in stress is prevented.

In some embodiments, a thickness of an outer circumferential end of the disk portion in the axis direction is equal to or less than a thickness of a rear edge of each blade portion located at the outer circumferential end. The weight of the outer circumferential side can significantly impact the inertia of the whole impeller. Inertia is effectively reduced by the thickness of the outer circumferential end of the disk portion being equal to or less than the thickness of the rear edge of the blade portion.

Embodiments according to the present disclosure will be described below with reference to the drawings. It should be noted that like elements are given like reference signs in the description of the drawings and redundant explanation is omitted.

An electric turbocharger (vehicle turbocharger) 1 having a compressor impeller (FRP impeller for a vehicle turbocharger) 8 according to a First Embodiment applied thereto is described with reference to FIG. 1. As shown in FIG. 1, the electric turbocharger 1 is applicable to an internal combustion engine of a vehicle. The electric turbocharger 1 includes a compressor 7. The electric turbocharger 1 rotates a compressor impeller 8 by interaction between a rotor part 13 and stator part 14 and compresses fluid such as air to generate compressed air.

The electric turbocharger 1 includes a rotating shaft 12 which is rotatably supported in a housing 2, and the compressor impeller 8 which is attached to a distal end (one end) 12a of the rotating shaft 12. The housing 2 includes a motor housing 3 that accommodates the rotor part 13 and the stator part 14, and an end wall 4 that closes an opening on another end (right side in the figure) of the motor housing 3. The motor housing 3 has, on the one end (left side in the figure), a compressor housing 6 that accommodates the compressor impeller 8. The compressor housing 6 includes an inlet port 9, a scroll portion 10, and an outlet port 11.

The compressor impeller 8 is made, for example, of carbon fiber reinforced thermo plastic (CFRTP) to reduce weight. The compressor impeller 8 may be made of carbon fiber reinforced plastic (CFRP). It should be noted that the material of the compressor impeller 8 is not limited thereto and may be other FRPs.

The rotor part 13 is fixed to a central portion of the rotating shaft 12 in an axis direction and includes a permanent magnet (not shown) attached to the rotating shaft 12. The stator part 14 is fixed to an inner surface of the motor housing 3 so as to surround the rotor part 13, and includes a coil portion (not shown). When an alternating current is passed through the coil portion of the stator part 14, the rotating shaft 12 and the compressor impeller 8 rotate in unison due to the interaction between the rotor part 13 and the stator part 14. When the compressor impeller 8 rotates, the compressor impeller 8 sucks in outside air through the inlet port 9, compresses the air through the scroll portion 10, and discharges the compressed air from the outlet port 11. The compressed air discharged from the outlet port 11 is supplied to the internal combustion engine mentioned above.

The electric turbocharger 1 includes two bearings 20 which are press fit into the rotating shaft 12 and rotatably support the rotating shaft 12 with respect to the housing 2. The bearings 20 are respectively provided near the distal end 12a and near a base end 12b of the rotating shaft 12, and support the rotating shaft 12 at both ends. The bearings 20 are, for example, grease-lubricated radial ball bearings. One of the bearings 20 is attached to a rear surface side (right side in the figure) of the compressor impeller 8. The compressor impeller 8 and the bearing 20 are fixed to the rotating shaft 12 by a shaft end nut 16 that is mounted on the distal end 12a of the rotating shaft 12. The other bearing 20 is attached between the rotating shaft 12 and the end wall 4. The rotating shaft 12 and the compressor impeller 8 and the rotor part 13 which are fixed to the rotating shaft 12 integrally form a rotating part inside the housing 2.

The compressor impeller 8 according to the embodiment will be described in detail with reference to FIG. 2. The compressor impeller 8 includes a cylindrical boss portion 31 that has an axis X, and a circular disk portion 32 that extends outward in a radius direction from the boss portion 31. The compressor impeller 8 further includes a plurality of blade portions 33 which protrudes outward in the radius direction and toward one side of an axis X direction from the boss portion 31 and the disk portion 32. One side of the axis X direction refers to the side in which the shaft end nut 16 is mounted to the compressor impeller 8 (i.e., toward the distal end 12a). The other side of the axis X direction refers to the side in which the bearing 20 is mounted to the compressor impeller 8 (i.e., toward the base end 12b).

The boss portion 31, the disk portion 32, and the blade portions 33 described above are integrally formed. As shown in FIG. 1, the distal end 12a of the rotating shaft 12 is inserted into a through hole of the boss portion 31 formed along the axis X. The shaft end nut 16 is attached to the distal end 12a that protrudes from a first end face 31a of the boss portion 31. A second end face 31b of the boss portion 31 may be located more toward the one side of the axis X direction than an end surface (end edge) 32d of the disk portion 32 which is located toward the other side of the axis X direction. That is, the second end face 31b of the boss portion 31 may be located set back from the end surface 32d of the disk portion 32. It should be noted that the second end face 31b of the boss portion 31 may be flush with the end surface 32d of the disk portion 32 or may protrude from the end surface 32d of the disk portion 32 in the axis X direction.

Each blade portion 33 includes a front edge 33a that is located toward the one side of the axis X direction and a rear edge 33b that is located at an outer circumferential end 32c of the disk portion 32. In this embodiment, the front edge 33a extends from the boss portion. The rear edge 33b extends from the disk portion toward the one side of the axis X direction. An average of angles formed between the front edge 33a and the axis X along the front edge 33a is greater than an angle formed between the rear edge 33b and the axis X along the rear edge 33b. The front edge 33a and the rear edge 33b are connected by an edge of the blade portion whose center of curvature is located outward in the radius direction toward the one side of the X direction. It should be noted that the plurality of blade portions 33 may include full blades that extend from an inlet to an outlet of the fluid and splitter blades that are disposed between adjacent full blades. In the description below, the blade portion 33 means a full blade.

The compressor impeller 8 according to the embodiment is characterized by its rear surface shape. The rear surface shape of the compressor impeller 8 will be described in detail below with reference to FIGS. 2 to 4. As shown in FIGS. 2 and 3, the disk portion 32 includes a front surface 32a on which the plurality of blade portions 33 are formed, and a rear surface 32b which is located opposite the front surface 32a in the axis X direction. The front surface 32a is formed on the one side of the axis X direction and the rear surface 32b is formed on the other side of the X axis direction. The disk portion 32 has, on the rear surface 32b, the flat annular end surface 32d and a recessed portion 40 which is formed inward of the end surface 32d in the radius direction. The flat annular end surface 32d according to the embodiment extends from an outer circumferential edge of the disk portion 32.

The circular recessed portion 40 formed between the end surface 32d and the boss portion 31 is recessed more toward the one side of the axis X direction than the end surface 32d. The recessed portion 40 has a shape that corresponds to the trajectory of curves shown in FIGS. 2 and 3 rotated 360° about the axis X. In other words, the recessed portion 40 has the same cross-sectional shape as those shown in FIGS. 2 and 3 in any plane including the axis X of the compressor impeller 8. The recessed portion 40 is circumferentially uniformly formed. Thus, in the following description in which reference is made to the cross-sectional shape, a portion represented by a “point” means that it is a circular “line.” However, although explanation is omitted in the embodiment, the actual impeller may have minute irregularities caused during production, thus not resulting in the cross-sectional shapes being exactly the same and the circular “line” being formed.

The recessed portion 40 includes an annular planar surface 34 that extends along the radius direction. The planar surface 34 extends, for example, in a direction perpendicular to the axis X. The planar surface 34 is located at a bottom portion of the recessed portion 40 that is farthest from the end surface 32d in the axis X direction. As shown in FIG. 4, a depth from the end surface 32d to the planar surface 34 in the axis X direction is a maximum depth Zbf.

As shown in FIGS. 2 and 3, the recessed portion 40 includes a first curved portion 36 which connects the planar surface 34 to the second end face 31b of the boss portion 31. This first curved portion 36 is continuous with an inner circumference of the planar surface 34 and forms a shape that protrudes toward the one side of the axis X direction. The recessed portion 40 includes a sloped surface 37 which connects the planar surface 34 to the end surface 32d. This sloped surface 37 is continuous with an outer circumference of the planar surface 34.

As shown in FIG. 3, the recessed portion 40 is funned between an inner endpoint Pa on an inner circumferential side and an outer endpoint Pe on an outer circumferential side. The inner endpoint Pa is located at a boundary between the second end face 31b of the boss portion 31 and the first curved portion 36. The outer endpoint Pe is located at a boundary between the sloped surface 37 and the end surface 32d. The planar surface 34 may be defined by a first point Pb on the inner circumferential side and a second point Pc on the outer circumferential side. In other words, the first point Pb is located at a boundary between the first curved portion 36 and the planar surface 34. The second point Pc is located at a boundary between the planar surface 34 and the sloped surface 37.

The sloped surface 37 includes a second curved portion 38 which is continuous with the outer circumference of the planar surface 34 and is shaped to protrude toward the one side of the axis X direction, and a third curved portion 39 which is continuous with the outer circumference of the second curved portion 38 and is shaped to protrude toward the other side of the axis X direction. In a cross-sectional shape taken in a plane including the axis X, the sloped surface 37 includes an inflection point Pd that is located at a boundary between the second curved portion 38 and the third curved portion 39. This inflection point Pd is a point at which gradient strength transitions from increasing to decreasing when viewed outward in the radius direction.

The rear surface 32b of the disk portion 32 includes an outer circumferential endpoint Pf of the end surface 32d. A thickness tf of the outer circumferential end 32c of the disk portion 32 in the axis X direction is equal to or less than a thickness of the rear edge 33b of the blade portion 33 located at the outer circumferential end 32c.

The rear surface shape of the disk portion 32 mentioned above will be described further in detail from the various aspects below.

FIG. 4 is a diagram showing the shapes of the recessed portion and the end surface of the compressor impeller 8. The ratio of the thickness from the end surface 32d to the planar surface 34 in the axis X direction (maximum depth Zbf) to a radius RD of the disk portion 32 may be 10 to 25%.

A predetermined depth region Ra that includes the planar surface 34 and has a depth in the axis X direction which is 10% or less of the maximum depth Zbf may be set for the recessed portion 40. As shown in FIG. 4, a first reference point P3 and a second reference point P4 that have a reference depth Zbd which is a depth that is 10% of the maximum depth Zbf are determined. The region between the first reference point P3 and the second reference point P4 is the predetermined depth region Ra. The ratio of the length of the predetermined depth region Ra in the radius direction to the radius RD of the disk portion 32 may be 10 to 25%. More specifically, the ratio of the length of the planar surface 34 in the radius direction to the radius RD of the disk portion 32 may be 5 to 8%.

Furthermore, a predetermined slope angle region Rb that includes the planar surface 34 and has a slope angle θ relative to the planar surface 34 of 20° or less may be set for the recessed portion 40. As shown in FIG. 4, a first contact point PI (first tangent line LT1) and a second contact point P2 (second tangent line LT2) that have slope angles θ of 20° are determined. The region between the first contact point PI and the second contact point P2 is the predetermined slope angle region Rb. The ratio of the length of the predetermined slope angle region Rb in the radius direction to the radius RD of the disk portion 32 may be 13 to 25%.

The inflection point Pd in the recessed portion 40 may be located at a position between 40 to 60% of the disk portion 32 in a radius RD direction from the axis X.

Low inertia and acceleration performance are required for the compressor impeller 8 for a vehicle turbocharger. Thus, in the compressor impeller 8, the recessed portion 40 allows for reduction in weight and in the moment of inertia. In this embodiment, stress that may occur in the compressor impeller 8 is considered on the basis of the material, FRP. In other words, the recessed portion 40 is formed within an allowable range of material strength. As a result, cost of the material is reduced, acceleration performance is increased, and power consumption of the electric turbocharger 1 is improved.

In this embodiment, peak stress that occurs in a CFRTP impeller and tip displacement are reduced by appropriately setting the following four parameters of the recessed portion 40.
(i) Radius of the first curved portion 36
(ii) Radius of the second curved portion 38
(iii) Length of the planar surface 34 in the radius direction
(iv) Maximum depth Zbf of the recessed portion 40 (depth of the planar surface 34)

FIG. 5 is a diagram showing the relationship between stress of parts of an impeller and inertia thereof in cases in which the shape of the recessed portion varies. Three types of impellers were contemplated for which normalized stress of a disk portion, blade base portions, and a bottom portion, and normalized inertia were obtained. It should be noted that the bottom portion is the portion at which the disk portion 32 is connected to the boss portion 31. Although the three types of impellers have different recessed portion shapes, the thicknesses tf of the outer circumferential ends 32c are the same.

In an impeller according to a comparative example that has no planar surface 34 and in which the depth of the recessed portion is greater than that of the embodiment above, the normalized inertia was 0.6. However, in this impeller, high stresses of 0.96, 1.27, and 1.43 were generated respectively in a bottom portion C, a disk portion A, and blade base portions B.

In an impeller according to a comparative example that has no planar surface 34 but in which the depth of the recessed portion is the same as that of the embodiment above, the not finalized inertia was 0.81. In this impeller, stresses of 0.85, 0.93, and 0.93 were generated respectively in the bottom portion C, the disk portion A, and the blade base portions B.

In an impeller according to an example that corresponds to the embodiment above, the normalized inertia was 0.81. In this impeller, the radius of the second curved portion 38 is greater than the radius of the first curved portion 36. In this impeller, stresses of 0.95, 0.95, and 0.76 were generated respectively in the bottom portion C, the disk portion A, and the blade base portions B. Thus, by having the planar surface 34 and appropriately setting the four parameters, the normalized stress of each part is kept at less than 1 while achieving low inertia.

FIG. 6 is a diagram showing the stress distribution on a rear surface of an FRP impeller for a vehicle turbocharger according to the example. FIG. 7 is a diagram showing the stress distribution on a rear surface of an FRP impeller for a vehicle turbocharger according to the comparative example. In the diagrams, the depth of color indicates the degree of stress.

The impeller according to the example has a configuration that corresponds to that of the embodiment above. As shown in FIG. 6, in the impeller according to the example, the stress is low in the disk portion A and rather high in the blade base portions B. The stress in the bottom portion C is as low as the stress in the disk portion A.

The impeller according to the comparative example has no planar surface 34 and has the recessed portion that is deeper than that of the impeller according to the example. As shown in FIG. 7, in the impeller according to the comparative example, the stress is rather high in the disk portion A and very high in the blade base portions B. The stress in the bottom portion C is also rather high.

In a traditional CFRTP impeller, a peak stress is generated in the bottom portion C as shown in FIG. 7. This portion can thus be called a critical location. The strength (fatigue strength) of the intended carbon fiber reinforced thermo plastic (CFRTP) drops sharply when the temperature exceeds 130° C., making it difficult to ensure durability. In the impeller according to the example, the stress in the bottom portion C is reduced by the four parameters above of the recessed portion 40.

In the compressor impeller 8 according to the embodiment, the recessed portion 40 formed in the rear surface 32b of the disk portion 32 can contribute to reducing inertia and improving acceleration performance. Since the recessed portion 40 has, on the bottom portion, the planar surface 34 that extends along the radius direction, the increase in stress is prevented compared to a case in which the recessed portion 40 is greatly hollowed out. Thus, the compressor impeller 8 is capable of preventing damage. In particular, the increase in stress is also appropriately prevented in a vehicle turbocharger that uses a thin rotating shaft 12.

The increase in stress is more appropriately prevented by the ratio of the maximum depth Zbf to the radius RD of the disk portion 32 being 10 to 25%.

Since the inflection point Pd is formed on the sloped surface 37 between the planar surface 34 and the end surface 32d, the shape of the recessed portion 40 from the planar surface 34 to the outer circumferential side is appropriately set.

The shape of the recessed portion 40 from the planar surface 34 to the outer circumferential side is optimized by the inflection point Pd being located at a position between 40 to 60% of the disk portion in the radius RD direction from the axis X.

The size of the region of the planar surface 34 to be formed in the recessed portion 40 is appropriately set by the ratio of the length of the predetermined depth region Ra (Zbd/Zbf=0.1) in the radius direction to the radius RD of the disk portion 32 being 10 to 25%. As a result, inertia is reduced and the increase in stress is prevented.

The size of the region of the planar surface 34 to be formed is optimized by the ratio of the length of the planar surface 34 in the radius direction to the radius RD of the disk portion 32 being 5 to 8%.

The size of the region that includes the planar surface 34 and both sides of the planar surface 34 in the radius direction may be appropriately set by the ratio of the length of the predetermined slope angle region Rb (slope angle θ=20°) in the radius direction to the radius RD of the disk portion 32 being 13 to 25%. As a result, inertia is reduced and the increase in stress is prevented.

Inertia is effectively reduced by the thickness tf of the outer circumferential end 32c of the disk portion 32 being equal to or less than the thickness of the rear edge 33b.

Although the embodiment of the present disclosure has been described above, the present invention is not limited thereto. The shape of the recessed portion 40 can be varied as appropriate. For example, as shown in FIG. 8, the compressor impeller 8 may be a compressor impeller 8A in which the recessed portion 40 has a depth smaller than that of the compressor impeller 8. The numerical ranges described above (numerical ranges relating to the planar surface 34, maximum depth Zbf, predetermined depth region Ra, predetermined slope angle region Rb, and thickness tf) are also satisfied in the compressor impeller 8A. In the compressor impeller 8A, the planar surface 34 is longer in the radius direction than the planar surface 34 of the compressor impeller 8. The predetermined slope angle region Rb (slope angle θ=20) is longer than the predetermined slope angle region Rb of the compressor impeller 8. The compressor impeller 8A produces the same operation and effect as those of the compressor impeller 8.

The FRP impeller for a vehicle turbocharger according to the present disclosure may be an impeller that does not satisfy any or a portion of the numerical ranges described above (numerical ranges relating to the planar surface 34, maximum depth Zbf, predetermined depth region Ra, predetermined slope angle region Rb, and thickness tf).

The FRP impeller for a vehicle turbocharger according to the present disclosure may be an impeller in which a metal piece/metal plate is inserted in the rear surface 32b of the disk portion 32.

The FRP impeller for a vehicle turbocharger according to the present disclosure may be applied to a turbocharger having a turbine.

### INDUSTRIAL APPLICABILITY

According to various embodiments of the present disclosure, an FRP impeller for a vehicle turbocharger that can prevent damage is provided.

### REFERENCE SIGNS LIST

1 Electric turbocharger (vehicle turbocharger)

### 7 Compressor

8 Compressor impeller (FRP impeller for a vehicle turbocharger)
31 Boss portion
32 Disk portion
32a Front surface
32b Rear surface
32c Outer circumferential end
32d End surface (end edge)
33 Blade portion
33a Front edge
33b Rear edge
34 Planar surface
37 Sloped surface
40 Recessed portion
Pd Inflection point
Ra Predetermined depth region
Rb Predetermined slope angle region

### RD Radius

tf Thickness (of outer circumferential end)

### X Axis

Zbf Maximum depth

1.-8. (canceled)

9. An FRP impeller for a vehicle turbocharger, comprising:
a boss portion being cylindrical and having an axis;
a disk portion extending outward in a radius direction from the boss portion; and
a plurality of blade portions protruding outward in the radius direction and toward one side of an axis direction along the axis from the boss portion and the disk portion,
wherein the disk portion includes a front surface on which the blade portions are formed, and a rear surface located opposite the front surface in the axis direction,
wherein the disk portion has, on the rear surface, an end edge being annular and located on another side of the axis direction, and a recessed portion formed inward of the end edge in the radius direction and recessed more toward the one side of the axis direction than the end edge,
wherein the recessed portion includes a planar surface being annular, located at a bottom portion of the recessed portion farthest from the end edge in the axis direction, and extending along the radius direction, and
wherein a ratio of a maximum depth being a depth from the end edge to the planar surface in the axis direction, to a radius of the disk portion is 10 to 25%.

10. The FRP impeller for a vehicle turbocharger according to claim 9,
wherein the recessed portion includes a sloped surface connecting the planar surface to the end edge, and
wherein the sloped surface includes an inflection point in a cross-sectional shape taken in a plane including the axis.

11. The FRP impeller for a vehicle turbocharger according to claim 10, wherein the inflection point is located at a position between 40 to 60% of the disk portion in the radius direction from the axis.

12. The FRP impeller for a vehicle turbocharger according to claim 9, wherein a ratio of a length in the radius direction of a region including the planar surface and having a depth in the axis direction 10% or less of the maximum depth, to the radius of the disk portion is 10 to 25%.

13. The FRP impeller for a vehicle turbocharger according to claim 9, wherein a ratio of a length of the planar surface in the radius direction to the radius of the disk portion is 5 to 8%.

14. The FRP impeller for a vehicle turbocharger according to claim 9, wherein a ratio of a length in the radius direction of a region including the planar surface and having a slope angle with respect to the planar surface of 20° or less, to the radius of the disk portion is 13 to 25%.

15. The FRP impeller for a vehicle turbocharger according to claim 9, wherein a thickness of an outer circumferential end of the disk portion in the axis direction is equal to or less than a thickness of a rear edge of each blade portion located at the outer circumferential end.
